(19) United States
(12) Patent Application Publication
(10) Pub. No.: US 2010/0296782 A1
(43) Pub. Date: Nov. 25, 2010

(54) OPTICAL FIBRE HAVING RESISTANCE TO HYDROGEN-INDUCED ATTENUATION

(76) Inventors: Ivan Vladimirovich Nikolin, Moscow (RU); Sergey Lvovich Semjonov, Moscow (RU); Alexey Fedorovich Kosolapov, Moscow (RU)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(21) Appl. No.: 12/739,529

(22) PCT Filed: Oct. 23, 2007
(86) PCT No.: PCT/RU07/00583

§ 371 Date: Aug. 10, 2010

(51) Int. Cl. G02B 6/02

(52) U.S. Cl. 385/126; 385/123

(57) ABSTRACT

An optical fiber having resistance to hydrogen-induced attenuation includes a core and cladding including silica. At least one of the core and the cladding includes a dopant capable of not increasing reactivity of the silica with hydrogen. An optical fiber assembly includes a core and cladding including silica. At least one of the core and the cladding includes a dopant capable of changing the refractive index of the fiber core or cladding while not increasing reactivity of the fiber with hydrogen. The optical fiber in some examples further includes a hermetic layer disposed about the cladding. Some implementations include a “getter” layer, which may be an outside part of the fiber cladding been inside the hermetic coating. The “getter” layer includes silica and a dopant increasing reactivity of the layer with hydrogen. The optical fiber assembly optionally includes a sheath disposed about the cladding.

### BACKGROUND

1. Field of the Invention

The present invention relates to optical fibers.

2. Description of Related Art

Optical fibers used in harsh environments often degrade over time. A primary source of degradation in oilfield applications is attack by hydrogen. The source of hydrogen in such applications is often corrosion. The amount of hydrogen generated by corrosion typically increases with temperature. Diffusion of hydrogen into optical fibers also increases with temperature. Generally, hydrogen diffusion into optical fibers causes optical signals to attenuate at particular wavelengths.

Typical optical fibers are made of silica (SiO₂) having a core doped with germanium. Typical optical fibers are not normally intended for use at temperatures above about 80° C. When these types of optical fibers are exposed to hydrogen, the optical attenuation increases at different rates, depending upon the wavelength of the optical signal, due to interactions between hydrogen and the silica of the optical fibers. The main features of the attenuation spectrum in the infrared region, as shown in FIG. 1, are a steep increase in attenuation at shorter wavelengths, known as “short wavelength edge,” and one or more absorption peaks related to hydroxyl (OH) groups generated by the reaction of hydrogen with the silica.

One type of optical fiber assembly known in the art addresses the problem of hydrogen diffusion by providing a hydrogen retarding layer about one or more glass layers. The hydrogen retarding layer slows the diffusion of hydrogen into the one or more glass layers. The hydrogen retarding layer, however, is most effective at lower temperatures, such as those temperatures encountered near the surface of an oil or gas well or in lower temperature wells, e.g., at temperatures less than about 150° C. Using a hydrogen retarding layer on the outside of an optical fiber, however, is less effective at the higher temperatures found in downhole oil and gas well implementations, where temperatures can reach well over 300° C.

There continues to be a need for optical fibers that can maintain optical properties even when exposed to hydrogen at elevated temperatures encountered in wellbore applications.

### SUMMARY OF THE INVENTION

One aspect of the invention is an optical fiber having resistance to hydrogen-induced attenuation. The optical fiber comprises a core including silica and a cladding including silica disposed about the exterior of the core. At least one of the core and the cladding includes a dopant that changes refractive index of the silica but does not substantially increase reactivity of the silica with hydrogen. In some examples, the optical fiber includes a hermetic layer disposed about the exterior of the cladding. In some examples, the optical fiber includes a sheath disposed about the exterior of the cladding.

Additional aspects, features and advantages will be apparent in the written description which follows.

### BRIEF DESCRIPTION OF THE DRAWINGS

FIG. 1 is an exemplary graph illustrating a conventional short wavelength edge and conventional a hydroxyl absorption peak in optical fibers made using techniques known in the art prior to the present invention.

FIG. 2 is a stylized, cross-sectional view of an illustrative example of an optical fiber assembly according to the present invention.

FIG. 3 is a stylized, cross-sectional view of an illustrative example of an optical fiber cable according to the present invention.

FIG. 4 is a graph illustrating exemplary optical losses versus wavelength for a phosphorus-doped optical fiber according to the present invention both before and after being subjected to hydrogen.

FIG. 5 is a graph illustrating exemplary optical losses versus wavelength for a fluorine-doped optical fiber according to the present invention both before and after being subjected to hydrogen.

FIG. 6 is a graph illustrating exemplary optical losses versus wavelength for a nitrogen-doped optical fiber according to the present invention both before and after being subjected to hydrogen.

FIG. 7 is a graph illustrating an exemplary index profile for an aluminum-doped optical fiber according to the present invention.

FIG. 8 is a graph illustrating exemplary optical losses versus wavelength for a germanium doped fiber and a germanium doped fiber using various amounts of phosphorous as a co-dopant;

FIG. 9 is a graph showing a comparison of test results for various dopants according to the invention.

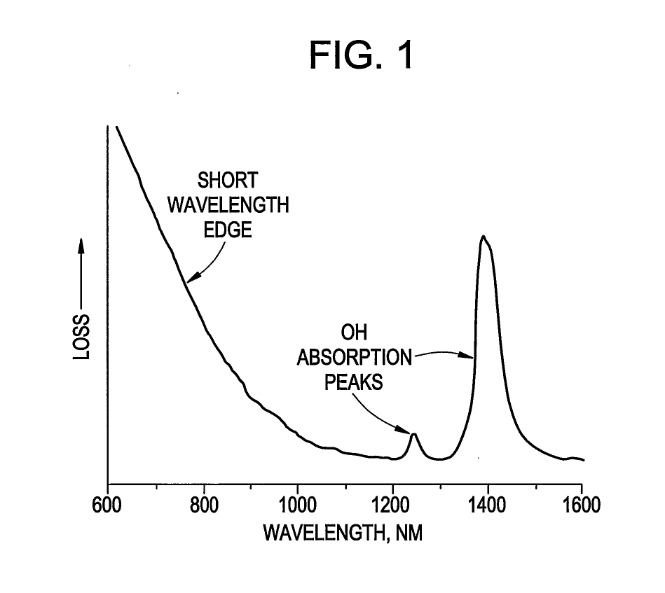

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The present invention represents an optical fiber particularly suited for use in high temperature environments. The optical fiber comprises silica glass doped with one or more oxidizer elements, which do not significantly modify the silica glass structure and do not form significant amounts of precursors to react with hydrogen. The optical fiber may be incorporated into an optical fiber assembly, which can include a hermetic coating applied about the optical fiber. The optical fiber assembly can further include a protective sheath disposed about the optical fiber or disposed about the hermetic coating, if present. Other conventional elements of optical fiber assemblies may be included in the present optical fiber assembly.

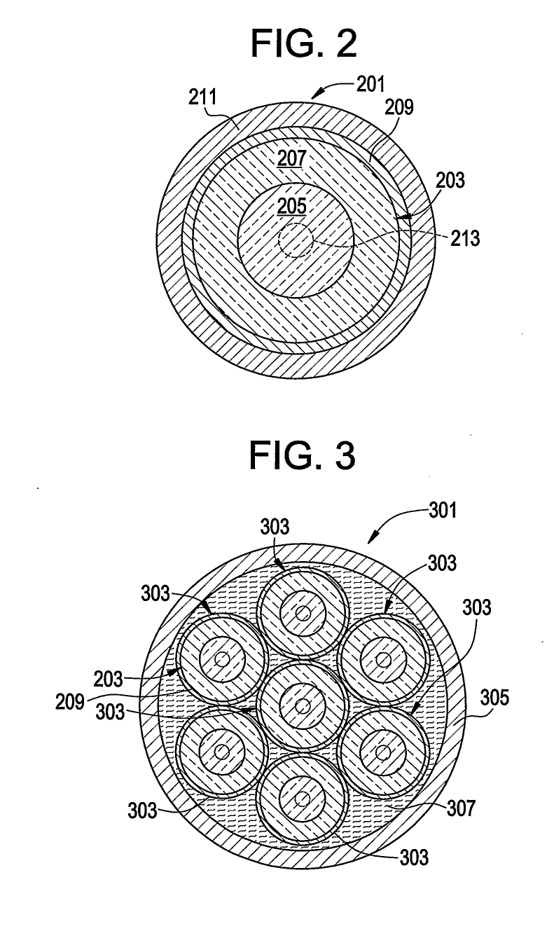

FIG. 2 depicts an illustrative embodiment of an optical fiber assembly 201 according to the present invention. In the illustrated embodiment, optical fiber assembly 201 comprises an optical fiber 203 including a core 205 and a cladding 207, a hermetic layer 209 disposed about optical fiber 203, and a sheath 211 disposed about hermetic layer 209. Alternatively, however, hermetic layer 209 or sheath 211 may be omitted. If hermetic layer 209 is omitted, sheath 211 is disposed about optical fiber 203. It should also be noted that the present invention contemplates one or more optical fibers 203, omitting both hermetic layer 209 and sheath 211.

Core 205 of optical fiber 203 comprises silica glass may be doped with one or more elements, which do not significantly modify the silica glass structure and do not form significant amounts of precursors to react with hydrogen. The doping elements are capable of changing the refractive index of the fiber core or cladding but at the same time not substantially increasing reactivity of the fiber 203 with hydrogen. Examples of the elements or “dopants” include, but are not limited to, nitrogen, fluorine, phosphorus, and aluminum.

In one embodiment, optical fiber 203 is constructed by forming a generally elongated cylindrical, optical waveguide structure, also known as a “preform” or a “blank.” The optical waveguide structure is preferably formed using a chemical vapor deposition process, which may be plasma-assisted. In one such process, oxygen is bubbled through solutions comprising the one or more dopant elements. The resulting vapors are then conducted to an internal cavity of a silica or quartz tube, which vapors ultimately form a cladding 207, while the tube is rotated generally about its longitudinal. As the tube is rotated, the tube is locally heated to a high temperature sufficient to cause the one or more dopant elements to react with oxygen, thus forming corresponding one or more oxides. The oxides are deposited on and fused to the inside of the tube, or are deposited on and fused to previously deposited oxide. The process is continued until a solid optical waveguide structure is formed.

It should be noted that the present invention contemplates an optical fiber that varies in composition in a radial direction from a central, longitudinal axis of the fiber. For example, in one embodiment, core 205 of optical fiber 203 is aluminum-doped in a central portion 213 (indicated by a dashed line) thereof. While central portion 213 of core 205 is depicted in FIG. 2 as having a particular size and a particular size with respect to core 205, the scope of the present invention is not so limited. Rather, central portion 213 may exhibit any suitable size and any suitable size with respect to core 205. In some examples, the core 205 and/or the cladding 207 may be made using silica doped with one or more dopants as will be described in more detail below. An exterior layer to the cladding 207 may be doped only with germanium in amounts typical for such doping as is known in the art. Having a germanium-doped exterior layer may provide the optical fiber with a reactive “getter” layer to reactively absorb hydrogen and reduce its diffusion into the cladding 207 and the core 205.

The optical waveguide structure is then drawn into optical fiber 203 of the present invention. During the drawing operation, the hermetic layer 209 may be applied to optical fiber 203 to further protect against hydrogen diffusion into core 205. Alternatively, hermetic layer 209 may be applied to optical fiber 203 after the drawing process. Preferably, hermetic layer 209 comprises carbon or a metallic material.

Referring to FIG. 3, optical fiber 203, with or without hermetic layer 209, may be bundled with one or more other optical fibers 203 in an optical fiber cable or assembly 301. In FIG. 3, an optical fiber assembly 303 comprises optical fiber 203 and hermetic layer 209. It should be noted that optical fibers 203 of optical fiber cable 301 may have arrangements that are different than the arrangement shown in FIG. 3. Moreover, in an alternative embodiment, one or more optical fibers 203 of optical fiber cable 301 may be replaced with conventional optical fibers or other conductors, such as electrical conductors, such that at least one optical fiber 203 is present in optical fiber cable 301. Optical fiber cable 301 preferably includes a sheath 305 formed about the one or more optical fibers 203 to protect the one or more optical fibers 203 from damage. A filler 307 may be disposed between sheath 305 and optical fiber assemblies 303.

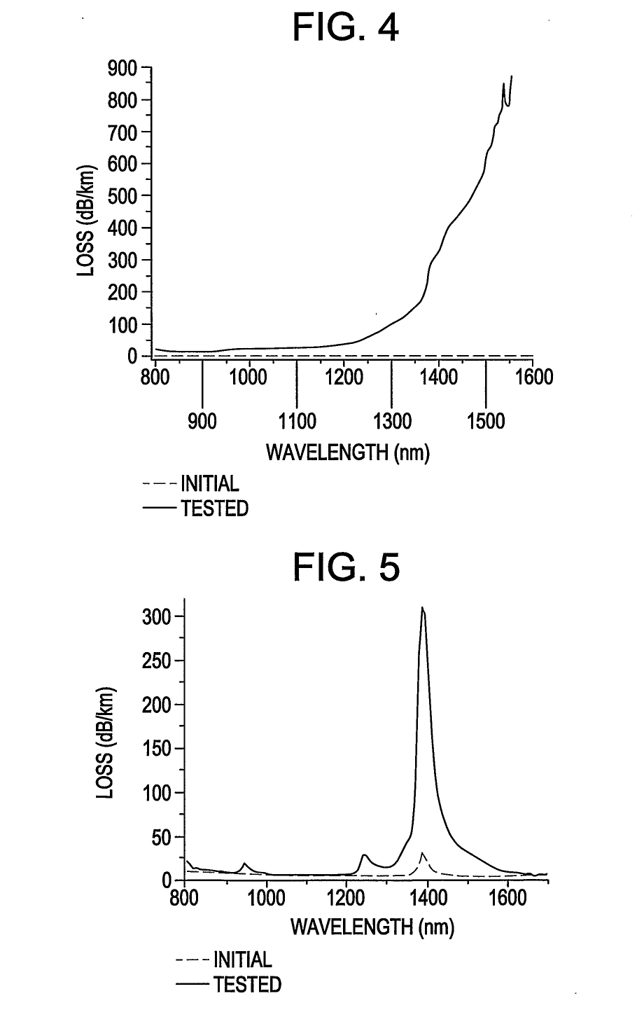

The graphs of FIGS. 4-9 provide the results of a series of tests conducted involving various embodiments of optical fiber 203. FIG. 4 graphically shows results of tests performed on a phosphorus-doped optical fiber 203. The dashed line in the graph illustrates a relatively low level of initial losses at wavelengths within a range of about 800 nm to about 1600 nm prior to the introduction of hydrogen. The solid line represents the attenuation of optical signals at wavelengths within a range of about 800 nm to about 1600 nm after subjecting optical fiber 203 to hydrogen at a pressure of about 50 atmospheres and at a temperature of about 300° C. for about 6 hours, followed by hydrogen out-diffusion. While losses are high at wavelengths above about 1350 nm, no short wavelength edge is exhibited. Such an embodiment of optical fiber 203 is particularly well-suited for many downhole, oilfield, distributed temperature sensing applications, which operate at wavelengths of about 1060 nm.

FIG. 5 relates to tests performed on a fluorine-doped optical fiber 203. The dashed line in the graph depicts only slight attenuation of optical signals at wavelengths within a range of about 800 nm to about 1600 nm due to OH interactions prior to the introduction of hydrogen. The solid line represents the attenuation of optical signals at wavelengths within a range of about 800 nm to about 1600 nm after subjecting optical fiber 203 to hydrogen at a pressure of about 50 atmospheres and at a temperature of about 300° C. for about 6 hours, followed by hydrogen out-diffusion. Only OH-related attenuation peaks grew, with no formation of a short wavelength edge. It was also discovered that fluorine-doped optical fiber 203 is less sensitive to hydrogen at elevated temperatures. As noted above, such an embodiment of optical fiber 203 is particularly well-suited for many downhole, oilfield, distributed temperature sensing applications, which operate at wavelengths of about 1060 nm.

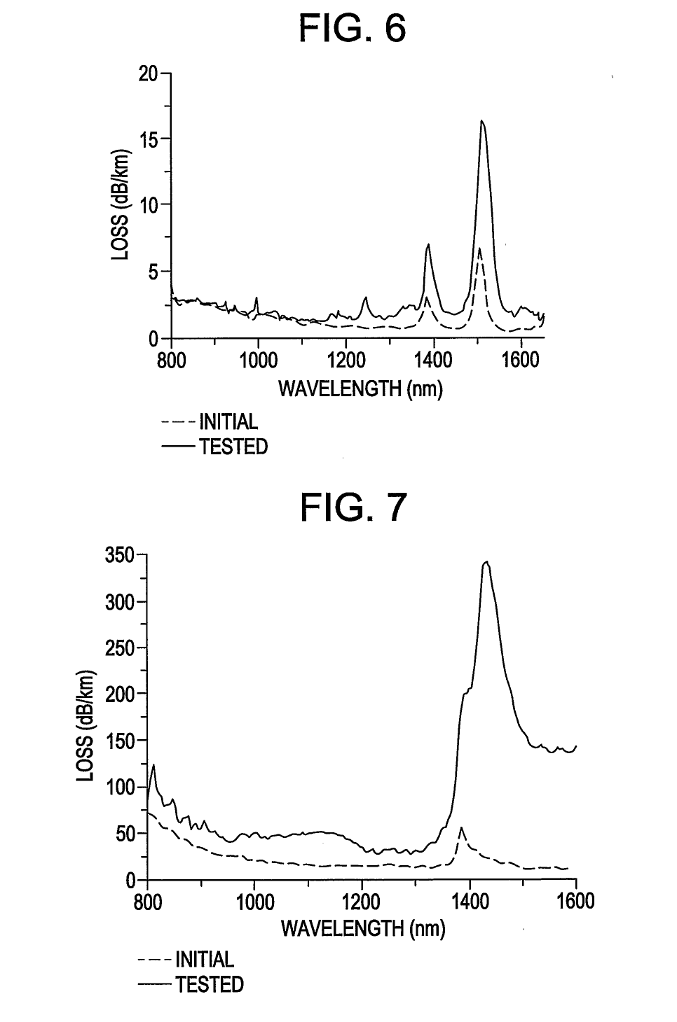

FIG. 6 relates to tests performed on a nitrogen-doped optical fiber 203. The dashed line in the graph depicts only slight attenuation of optical signals at wavelengths within a range of about 800 nm to about 1600 nm due to OH interactions prior to the introduction of hydrogen. The solid line represents the attenuation of optical signals at wavelengths within a range of about 800 nm to about 1600 nm after subjecting optical fiber 203 to hydrogen at a pressure of about 50 atmospheres and at a temperature of about 300° C. for about 6 hours, followed by hydrogen out-diffusion. Only OH-related attenuation peaks grew, with no formation of a short wavelength edge. It was also discovered that, as with fluorine-doped optical fiber 203, nitrogen-doped optical fiber 203 is less sensitive to hydrogen at elevated temperatures. As noted above, such an embodiment of optical fiber 203 is particularly well-suited for many downhole, oilfield, distributed temperature sensing applications, which operate at wavelengths of about 1060 nm.

FIG. 7 graphically shows tests performed on an aluminum-doped optical fiber (203 in FIG. 2). The dashed line in the graph depicts only slight attenuation of optical signals at wavelengths within a range of about 800 nm to about 1600 nm due to OH interactions prior to the introduction of hydrogen. The solid line represents the attenuation of optical signals at wavelengths within a range of about 800 nm to about 1600 nm after subjecting the optical fiber to hydrogen at a pressure of about 50 atmospheres and at a temperature of about 300° C. for about 6 hours, followed by hydrogen out-diffusion. Only the OH-related attenuation peaks increased, and the optical fiber showed essentially no formation of a short wavelength edge. It was also discovered that fluorine-doped optical fiber is less sensitive to hydrogen at elevated temperatures. As noted above, such an embodiment of optical fiber 203 is particularly well-suited for many downhole, oilfield applications such as distributed temperature sensors, which typically operate at wavelengths of about 1060 nm.

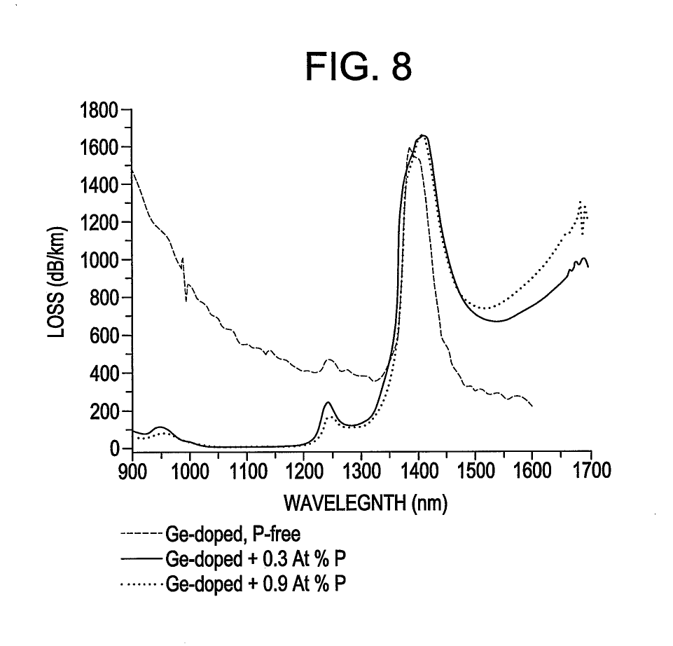

FIG. 8 graphically shows results of relates performed on a germanium-doped optical fiber co-doped with small amounts of phosphorus. The various curves in the graph represent the attenuation of optical signals at wavelengths within a range of about 900 nm to about 1600 nm after subjecting optical fibers 203 to hydrogen at a pressure of about 1 atmosphere and at a temperature of about 300° C. for about 6 hours, followed by hydrogen out-diffusion. One curve represents the response for a germanium-only doped fiber. Another curve represents the response for a germanium plus 0.3% phosphorus doped fiber. The final curve represents the response for germanium plus 0.9% phosphorous doped fiber. In the fibers with phosphorus co-doping, OH-related attenuation peaks increased, however there was significantly smaller formation of a short wavelength edge than in germanium-doped, phosphorus-free fibers. It was also discovered that germanium-doped optical fiber 203 with phosphorus co-doping is less sensitive to hydrogen at elevated temperatures. As noted above, such an example of optical fiber 203 is particularly well-suited for many downhole (in wellbore), oilfield applications, which operate at wavelengths of about 1060 nm.

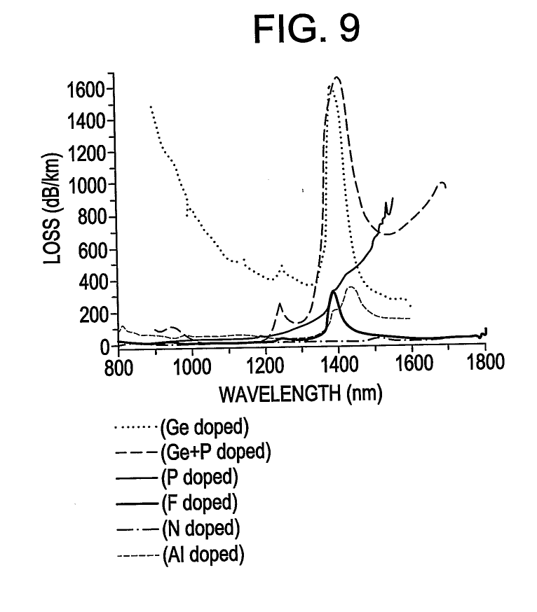

Aluminum-doped optical fiber 203 was then subjected to hydrogen at a pressure of about 1 atmosphere and at a temperature of about 300° C. for about 130 hours, followed by an increase in hydrogen pressure to about 40 atmospheres for an additional time of about 55 hours to accelerate the test. FIG. 9 depicts the resulting optical attenuations, recalculated for 1 atmosphere of hydrogen pressure. The OH-induced peak at about 1380 nm increased over time. No short wavelength edge, however, was induced in aluminum-doped optical fiber 203. Moreover, regions of the measured spectrum other than at the OH-induced peak exhibited significantly lower attenuation values than conventional germanium- or germanium+phosphorus-doped optical fibers.

Thus, optical fiber 203 inhibits the development of short wavelength edges and induced attenuation peaks when optical fiber 203 is subjected to hydrogen. In one embodiment, optical fiber 203 comprises phosphorus doping to inhibit increases in short wavelength edge attenuation when optical fiber 203 is subjected to hydrogen. In another embodiment, optical fiber 203 comprises phosphorus, co-doped with another element, such as fluorine, germanium, nitrogen, or aluminum, to inhibit increases in short wavelength edge attenuation when optical fiber 203 is subjected to hydrogen. In yet another embodiment, optical fiber 203 comprises fluorine doping to inhibit attenuation increases when optical fiber 203 is subjected to hydrogen. In another embodiment, optical fiber 203 comprises fluorine, co-doped with another element, such as phosphorus, germanium, nitrogen, or aluminum, to inhibit increases in attenuation when optical fiber 203 is subjected to hydrogen.

In yet another embodiment, optical fiber 203 comprises nitrogen. In another embodiment, optical fiber 203 comprises aluminum.

A comparison of results of testing various dopants used in making optical fibers and subjecting the fibers to hydrogen is shown in graphic form in FIG. 9. The various curves in FIG. 9 represent optical attenuation after hydrogen exposure to silica fibers doped with the various elements shown. In comparison with germanium-only doped fibers, all of the tested dopants provided the optical fiber with substantially reduced attenuation due to hydrogen diffusion in a wavelength range of about 800 to 1200 nm.

The effective amount of any particular doping element may be different for each element. For nitrogen, fluorine, phosphorous and aluminum, for example, the effective amount must be enough to form the appropriate refractive index profile in the optical fiber. For example silica may be doped with 0.4 at % nitrogen to 4 at % nitrogen to form the necessary refractive index profile depending on the particular application for the optical fiber. For other dopants, the effective amount may be different.

It will be appreciated by those skilled in the art that the various dopants are used to modify the refractive index of the silica used to make the core and the cladding, such that the optical fiber can act as a waveguide. In any example of an optical fiber, therefore, the element used as a dopant, the amount of the dopant and its inclusion into either the cladding and/or the core should be selected to provide the appropriate refractive index to the core and to the cladding such that the optical fiber can act as an optical waveguide. Using dopants as suggested herein may reduce effects of hydrogen on the optical fiber.

The particular examples described above are illustrative only, as the invention may be modified and practiced in different but equivalent manners apparent to those skilled in the art having the benefit of the teachings herein. Furthermore, no limitations are intended with respect to the details of construction or design herein shown, other than as described in the claims below. It is therefore evident that the particular examples described above may be altered or modified and all such variations are considered within the scope of the invention. Accordingly, the scope of what has been invented shall be defined only by the appended claims.

1. An optical fiber having resistance to hydrogen-induced attenuation, comprising: a core including silica; and a cladding including silica, at least one of the core and the cladding including a dopant capable of changing the refractive index of at least one of the core and the cladding and not substantially increasing reactivity of the silica with hydrogen.

2. The optical fiber according to claim 1, wherein the dopant comprises an element selected from the group consisting of nitrogen, fluorine, phosphorus, and aluminum.

3. The optical fiber according to claim 1, wherein the dopant is capable of inhibiting generation of a short wavelength edge within a range of wavelengths from about 800 nanometers (nm) to about 1600 nm when the core is subjected to hydrogen.

4. The optical fiber according to claim 1, wherein the dopant is capable of inhibiting attenuation, other than hydroxyl-induced attenuation, within a range of wavelengths from about 800 nm to about 1600 nanometers when the core is subjected to hydrogen.

5. The optical fiber according to claim 1, wherein the core further comprises a central portion doped with aluminum.

6. The optical fiber according to claim 1, wherein the dopant comprises phosphorus co-doped with an element selected from the group consisting of fluorine, germanium, nitrogen, and aluminum.

7. The optical fiber according to claim 1, wherein the dopant comprises fluorine.

8. The optical fiber according to claim 1, wherein the dopant comprises nitrogen.

9. The optical fiber according to claim 1, wherein the core includes germanium as a dopant co-doped with phosphorus.

10. The optical fiber according to claim 1, wherein the dopant comprises aluminum.

11. The optical fiber according to claim 1, wherein the optical fiber is formed using a chemical vapor deposition process.

12. The optical fiber according to claim 11, wherein the chemical vapor deposition process is plasma-assisted.

13. The optical fiber according to claim 1, further comprising a silica layer disposed outside the cladding, the silica layer doped with a material causing higher reactivity to hydrogen than the dopant.

14. The optical fiber according to claim 13, wherein the material comprises germanium.

15. An optical fiber assembly, comprising: a core including silica; and a cladding including silica, at least one of the core and the cladding including a dopant capable of changing the refractive index of the fiber core or cladding and not substantially increasing reactivity of the fiber with hydrogen; and a hermetic layer disposed about the cladding.

16. The optical fiber assembly according to claim 15, wherein the dopant comprises: an element selected from the group consisting of nitrogen, fluorine, phosphorus, and aluminum.

17. The optical fiber assembly according to claim 15, further comprising: a sheath disposed outside the fiber cladding and outside the hermetic layer.

18. The optical fiber assembly according to claim 17, further comprising: a filler disposed between the sheath and the hermetic layer.

19. The optical fiber assembly according to claim 15, wherein the core further comprises a central portion doped with aluminum.

20. The optical fiber assembly, according to claim 15, wherein the fiber includes germanium as a dopant.

21. The optical fiber assembly according to claim 15, further comprising a silica layer disposed in an outside part of the fiber cladding, the silica layer doped with a material causing higher reactivity to hydrogen than the reactivity of pure silica.

22. The optical fiber assembly of claim 21, wherein the material comprises germanium.

23. An optical fiber assembly, comprising: a core including silica; a cladding disposed about the core, the cladding including silica, at least one of the core and the cladding including a dopant capable of changing the refractive index of the silica and not substantially increasing reactivity of hydrogen with the silica; and a sheath disposed about the cladding.

24. The optical fiber assembly according to claim 23, wherein the dopant comprises: an element selected from the group consisting of nitrogen, fluorine, phosphorus, and aluminum.

25. The optical fiber assembly according to claim 23, further comprising: a second core including silica; and a second cladding disposed about the second core; wherein the sheath is disposed about the cladding and the second cladding.

26. The optical fiber assembly according to claim 25, wherein the second cladding includes a dopant capable of changing refractive index of the silica in the second cladding while not increasing reactivity of the silica with hydrogen.

27. The optical fiber assembly according to claim 25, further comprising: a hermetic layer disposed about the second cladding.

28. The optical fiber according to claim 25, further comprising a silica layer disposed outside the cladding, the silica layer doped with a material causing higher reactivity to hydrogen than the dopant.

29. The optical fiber according to claim 28, wherein the material comprises germanium.
